(19) United States
(12) Patent Application Publication
(10) Pub. No.: US 2024/0193707 A1
(43) Pub. Date: Jun. 13, 2024

(54) METHODS AND SYSTEMS FOR AGRICULTURAL YIELD DATA MANAGEMENT

(71) Applicant: Dark Horse Ag Ventures Ltd., Saskatoon (CA)

(72) Inventors: Tyler LEFLEY, Saskatoon (CA); Garrett FRASER, Rocky View Country (CA); Elston SOLBERG, Edmonton (CA); Alexei MELNITCHOUCK, Calgary (CA)

(21) Appl. No.: 18/534,032

(22) Filed: Dec. 8, 2023

Related U.S. Application Data
(60) Provisional application No. 63/431,351, filed on Dec. 9, 2022.

(51) Int. Cl. G06Q 50/02; G06Q 10/0639

(52) U.S. Cl. CPC G06Q 50/02; G06Q 10/06393

(57) ABSTRACT

Systems and methods for reliable estimation of granular yield data for any field, based on historical, point-to-point yields. Productivity maps are generated while minimizing error due to outlier data points or other inconsistencies that may be present in the historical yield data. Leveraging and merging historical yield data layers allows for the use of data generated on a farm to be used to generate accurate management zones for allocating inputs.

### CROSS-REFERENCE TO RELATED APPLICATION

This application claims the benefit of U.S. Provisional Patent Application No. 63/431,351, the entire content of which is incorporated herein by this reference.

### TECHNICAL FIELD

The disclosed exemplary embodiments relate to agricultural management and, in particular, to agricultural yield management.

### BACKGROUND

One aspect of farm management is the use of yield data from previous crops to estimate future yields for a particular field. Conventionally, agronomists may estimate future yields based on point-in-time snapshots of a field, such as satellite images. Alternatively, farmers may maintain coarse, field-level yield data. However, for any given field, there may be significantly yield variability within the field itself. This is due to a wide variety of factors, such as soil quality, ground water, irrigation methods, fertilization methods, proximity to field boundaries, pests, and many more.

### SUMMARY

The following summary is intended to introduce the reader to various aspects of the detailed description, but not to define or delimit any invention.

In at least one broad aspect, there is provided a method for agricultural yield management, the method comprising: obtaining a plurality of seasonal yield datasets for a field, each of the plurality of seasonal yield datasets containing a respective plurality of point yields corresponding to a plurality of locations of the field; determining a plurality of seasonal average yields for the field based on the plurality of seasonal yield datasets; for each of the plurality of seasonal yield datasets, computing a respective plurality of normalized yield values based on the respective plurality of point yields and the respective seasonal average yield for the field; filtering the plurality of normalized yield values to eliminate outlier values and generate a plurality of filtered normalized yield values; computing a plurality of productivity values, each of the productivity values corresponding to a respective location of the field, each of the productivity values based on the respective filtered normalized yield values corresponding to the respective location; generating a productivity map for the field based on the plurality of productivity values.

In some cases, the obtaining the plurality of seasonal yield datasets for the field comprises using vegetation indices obtained from at least one of satellite, aerial, and drone imagery to substitute incomplete calibrated yield data.

In some cases, the vegetation indices are at least one of a Normalized Difference Vegetation Index (NDVI) or an Enhanced Vegetation index (EVI).

In some cases, the method further comprises computing a yield output for the field for a crop based on the productivity map.

In some cases, the method further comprises binning the plurality of productivity values based on a predetermined number of productivity ranges, to generate a plurality of binned productivity values.

In some cases, the predetermined number of productivity ranges is at least 2.

In some cases, the method further comprises identifying a plurality of management zones on the productivity map based on the plurality of productivity values.

In some cases, the contours of each of the plurality of management zones are determined by clustering the plurality of productivity values

In some cases, the filtering comprises, for each location, eliminating one or

more normalized yield values that exceed an upper threshold.

In some cases, the upper threshold is a fourth quartile of the plurality of normalized yield values for the respective location.

In some cases, the filtering comprises, for each location, eliminating one or more normalized yield values that exceed a lower threshold.

In some cases, the lower threshold is a first quartile of the plurality of normalized yield values for the respective location.

In some cases, the plurality of locations of the field are determined based on a grid pattern, and wherein the grid pattern is based on latitude and longitude.

In some cases, the method further comprises instructing a spreader to increase or decrease spreading density based on a location of the spreader relative to the productivity map.

In another broad aspect, there is provided a system for agricultural yield management, the system comprising: a memory storing a plurality of seasonal yield datasets for a field, each of the plurality of seasonal yield datasets containing a respective plurality of point yields corresponding to a plurality of locations of the field; a processor, the processor configured to carry out the methods described herein; and, optionally, a spreader controlled by the processor.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic block diagram of a system for yield management in accordance with at least one embodiment;

FIG. 2 is a simplified block diagram of a computer in accordance with some embodiments;

FIGS. 3A and 3B are example yield maps and productivity maps, respectively, for a first unit of time for an example field;

FIGS. 3C and 3D are example yield maps and productivity maps, respectively, for a second unit of time for the example field;

FIGS. 3E and 3F are example yield maps and productivity maps, respectively, for a third unit of time for the example field;

FIGS. 3G and 3H are example yield maps and productivity maps, respectively, for a fourth unit of time for the example field;

FIG. 3I is an example average productivity map based on the productivity maps of FIGS. 3B, 3D, 3F and 3H;

FIGS. 3J to 3M are filtered productivity maps based on the productivity maps of FIGS. 3B, 3D, 3F and 3H;

FIG. 3N is a filtered productivity map for the example field;

FIG. 3O is a delineated productivity map for the example field;

FIG. 4 is a flow chart diagram for an example method of yield management in accordance with at least some embodiments;

FIG. 5 is an example plot of a non-parametric distribution; and

FIG. 6 is a simplified block diagram of recalculation of a vegetation index to yield values in accordance with at least one embodiment.

### DETAILED DESCRIPTION

Estimation of yields is used not only to estimate output for a given crop. In particular, yield estimation can be used to determine the amount of seed and fertilizer that should be applied to obtain an achievable and desired target yield rate for a field. However, given that yield varies from point to point even within a field, the application of seed and fertilizer can be further optimized to apply more densely in portions of a field—also known as zones—that consistently show high yield and, conversely, more sparsely in other zones that consistently show low yield.

However, it may be difficult to identify the precise points within a field that produce high or low yield, owing to a wide variety of errors and outliers that may exist in historical yield data, such as:
Changing crop rotations;
Changing mapping approaches;
Use of different crop varieties;
Changes in weed resistance to pesticides;
Logistical problems spreading seed;
Logistical problems spreading fertilizer;
Logistical problems spraying pesticides;
Changing field boundaries;
Insect infestations;
Flooding;
Drought; and
Soil and airborne diseases (e.g., clubroot, rust, etc.).

Manual cleaning of yield data to eliminate these multiple sources of error requires specific knowledge of the field to which the yield data applies, along with statistical knowledge, and is nevertheless time-consuming and error prone. Accordingly, it is to be expected that yield data will almost always contain errors and outliers.

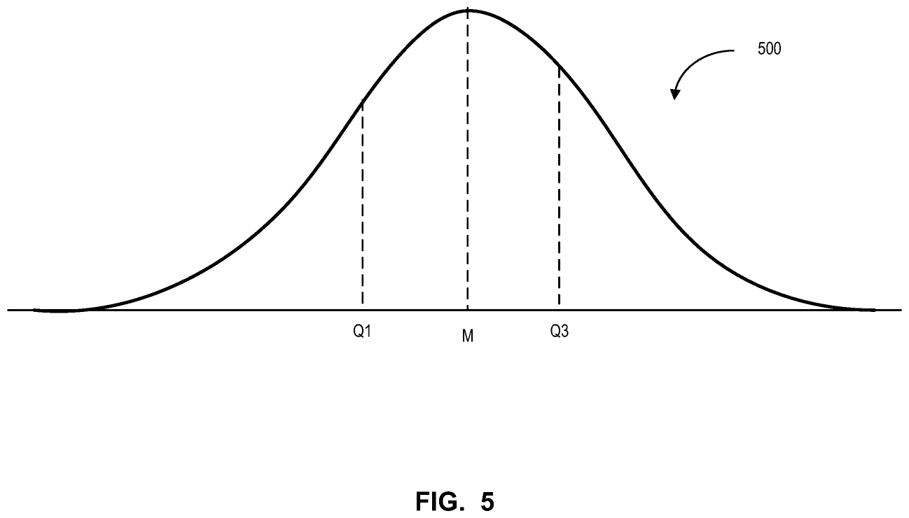

Attempts have been made to obtain parametric models of yield data; however these have proven to be unworkable due to, e.g., the high degree of variability based on site-specific factors. Yield data for fields instead generally displays a skewed, non-parametric distribution, such as in the example histogram shown in FIG. 5. That is, for any given field, there may be small range of productivity values that form a first end of the range (e.g., first quartile), and a relatively large range of productivity values forming a second end of the range (e.g., fourth quartile). However, the balance of the productivity values falls between these two end ranges (e.g., second and third quartiles).

The described embodiments provide for reliable estimation of granular yield data for any field, based on historical, point-to-point yields. Moreover, the described embodiments provide for eliminating or reducing error due to outlier data points or other inconsistencies that may be present in the historical yield data.

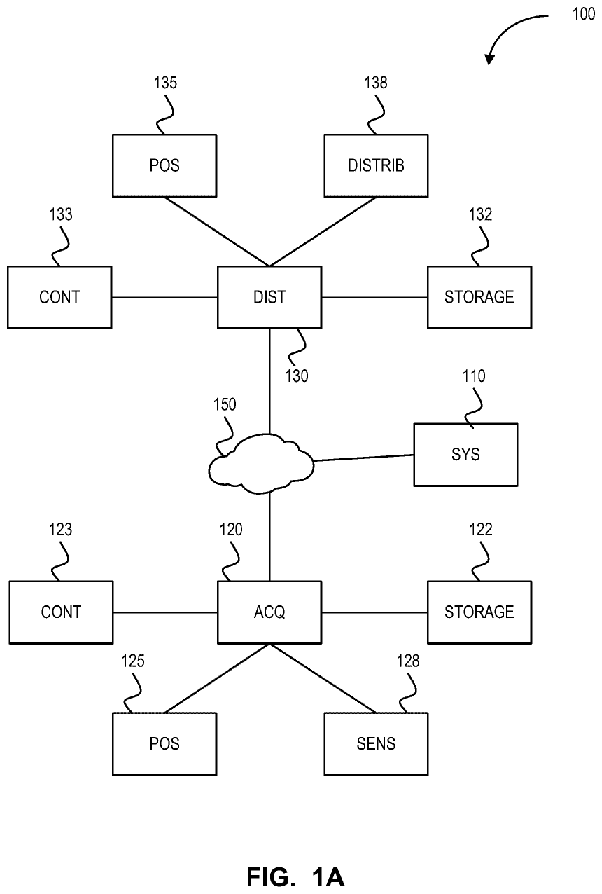

Referring now to FIG. 1, there is illustrated a schematic block diagram of a yield management system in accordance with at least some embodiments.

System 100 has one or more application server 110 (for ease of illustration only application server 110 is shown). In some embodiments, system 100 may have one or more data acquisition element 120, one or more distribution element 130. Optionally, server 110 may be communicatively coupled to data acquisition element 120 and/or distribution element 130 via a data network 150, such as a cellular or satellite data network. Alternatively, data may be exchanged between server 110, data acquisition element 120 and/or distribution element 130, via offline approaches, such as a data storage device (e.g., flash drive).

Data acquisition element 120 may be equipped with a position sensor 125, such as a Global Positioning System (GPS) unit, a memory 122, a controller 123 and a product sensor 128. In some cases, data acquisition element is a farm implement used to harvest a crop, such as a harvester. Accordingly, the product sensor 128 can be used by the controller 123 in combination with the position sensor 125 to record in the memory 122 a volume or weight of harvested crop for a predetermined area of a field, and thereby generate a yield map for a field for a particular harvesting season. In some alternative embodiments, data acquisition element 120 may be a satellite imaging system, that generates yield maps from satellite imaging.

In similar fashion, distribution element 130 may be equipped with a position sensor 135, a controller 133, a memory 132 and a distributor 138. Distribution element 130 is generally a farm implement that is used to distribute or spread some product. Distribution element 130 may be a fertilizer dispenser, such as a manure spreader or a sprayer, a pesticide dispenser, such as a sprayer, or a planter or seeding machine.

In operation, controller 133 may determine the location of the distribution element 130 using position sensor 135 and control the distributor 138 to dispense a desired amount of product based on a map stored in memory 132. For example, when distribution element 130 is a seed spreader, the controller 133 may direct the distributor 138 to increase seed dispensing in locations identified on the map for dense seeding, and to decrease seed dispensing in locations identified on the map for sparse seeding. Similarly, the controller can be used to increase or decrease the application of fertilizer or pesticides depending on the map.

In some cases, the functions of some or all of application server 110, data acquisition element 120 and distribution element 130 may be combined in a single apparatus.

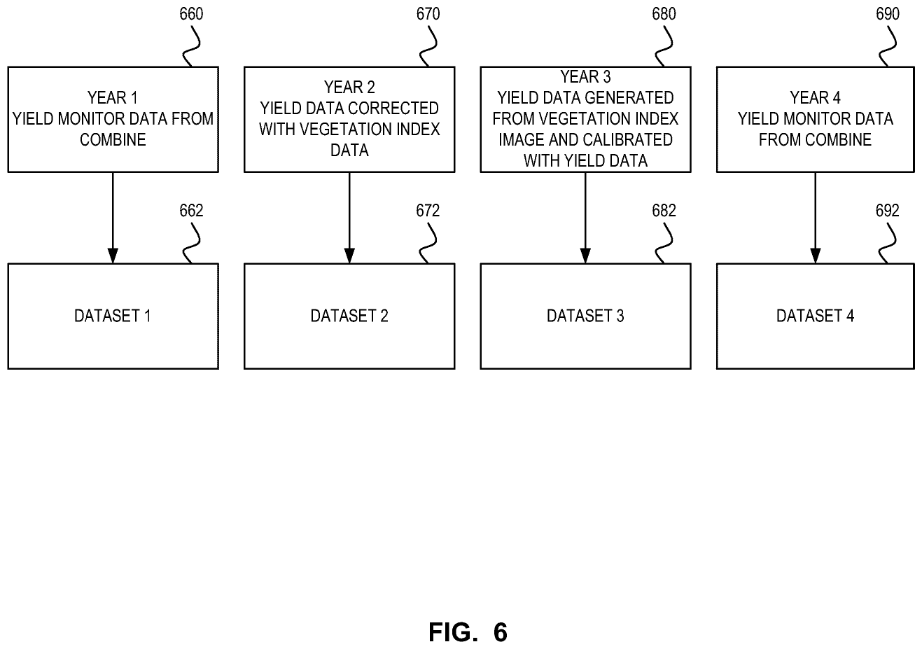

Referring now to FIG. 6, there is illustrated a simplified block diagram of recalculation of a vegetation index to yield values. The yield values may be in bushels per acre (bu/ac), tons per hectare (t/ha), or any other units that can be used to measure or quantify yield

If yield monitoring data from certain years are incomplete, missing, corrupted, or not calibrated well, vegetation indices obtained from satellite, aerial, or drone imagery can be used instead of yield data. Examples of vegetation indices can be (but are not limited to): Normalized Difference Vegetation Index (NDVI), Enhanced Vegetation index (EVI), etc. Since vegetation indices may have different ranges of values between classes compared to yield monitoring data, the vegetation index can be rescaled using the actual yield values from either historical or current yield monitoring data.

The process of using vegetation index data for generation of a yield dataset includes: (i) generation of a vegetation index dataset for the agricultural field; (ii) usage of a partial or whole yield monitoring dataset to obtain the yield range (i.e. minimum to maximum yield) for the agricultural field, and the average, field specific ratio between low, medium, and high yield classes and vegetation index classes within the field; and (iii) recalculation of vegetation index values to yield values using the ratio obtained in the step (ii).

At block 660, yield monitor data from, for example, a combine is obtained for a first year. At block 662 the obtained first year data forms a first dataset. At block 670, yield data for the second year is corrected with vegetation index data. At block 672, the corrected second year data forms a second dataset. At block 680, yield data for a third year is generated from a vegetation index image and calibrated with yield data. At block 682, the generated third year data forms a third data set. At block 690, yield monitor data from the combine is obtained for a fourth year. At block 692, the obtained fourth year data forms a fourth dataset.

Referring now to FIG. 2, there is illustrated a simplified block diagram of a computer in accordance with at least some embodiments. Computer 200 is a generic example of a computer, such as application server 110, data acquisition element 120 and distribution element 130 of FIG. 1. Computer 200 generally has at least one processor 210 operatively coupled to at least one memory 220, and at least one additional input/output device 290.

The at least one memory 220 includes a volatile memory that stores instructions executed or executable by processor 210, and input and output data used or generated during execution of the instructions. Memory 220 may also include non-volatile memory used to store input and/or output data along with program code containing executable instructions.

Processor 210 may transmit or receive data via a data communications interface (not shown), or may also transmit or receive data via any additional input/output device 240 as appropriate.

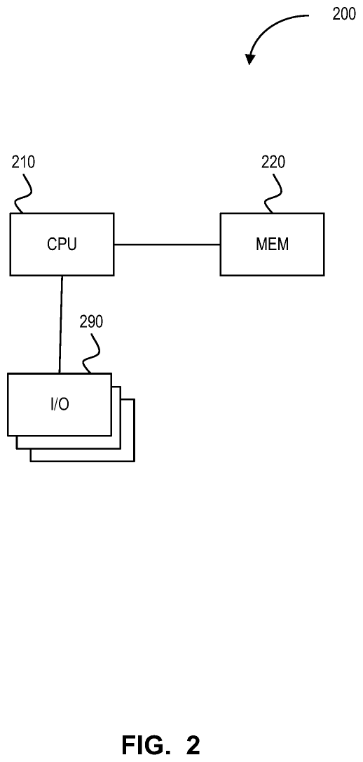

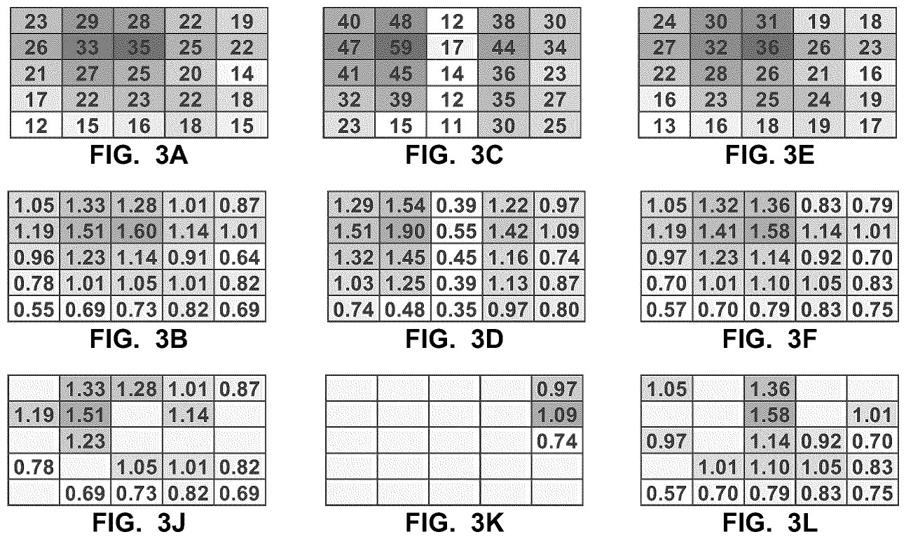

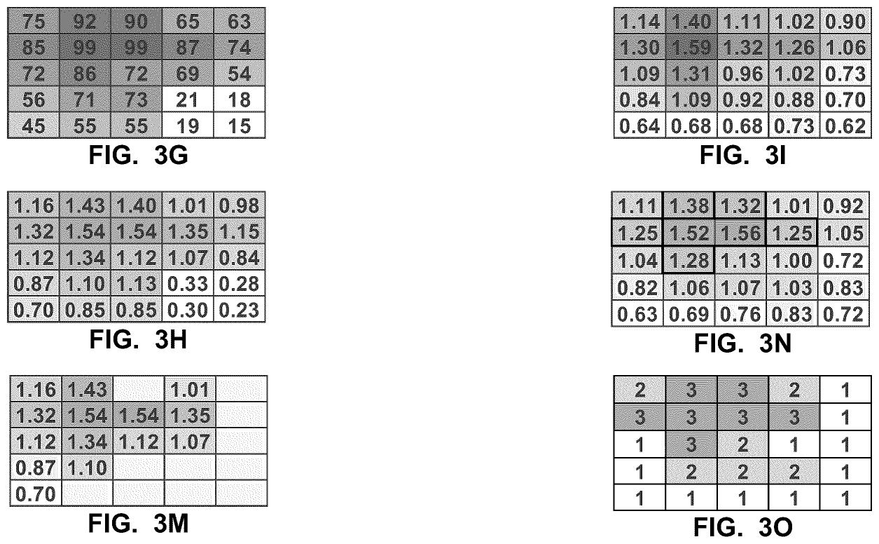

Referring now to FIGS. 3A and 3B, there is illustrated an example yield map of a field for a unit length of time, such as one crop year or one planting season. The map is subdivided, e.g., into a grid based on latitude and longitude, forming a plurality of field locations 310. Each field location is overlaid with a numerical value, representing a point yield for that grid location (e.g., measured in appropriate units, such as bushels, kilograms, etc.). In the example shown, the grid is also shaded to visually indicate areas of higher yield (darker) as opposed to areas of lower yield (lighter).

In the example of FIG. 3A, the total yield of the 25 field locations is 547 units, representing an average of approximately 22 units per field location.

Generally, all yield values for a field affect the field average. For any given field, it is possible to obtain a normalized productivity rating R for a given unit of time (e.g., crop season or year) by collecting point yields for a field and dividing by the average taken over all point yields for the unit of time. Since the normalized productivity rating R is an average, it may be considered independent of the specific crop, and thus be used across all crops and seasons.

FIG. 3B illustrates the normalized productivity values (R) for the field and unit of time of FIG. 3A.

FIGS. 3C and 3D illustrate example yield maps and normalized productivity values, respectively, for the same field as in FIGS. 3A and 3B, but for a second unit of time, which may correspond to a different crop. In the example of FIGS. 3C and 3D, the total yield is 777 units, with an average of 31 units. It will be noted that the yield values in the third column show a marked decline relative to the same column in FIGS. 3A and 3B. This may represent factors such as, e.g., a mechanical failure in seeding, flooding, or overspraying of pesticides affecting these field locations.

FIGS. 3E and 3F illustrate example yield maps and normalized productivity values, respectively, for the same field as in FIGS. 3A and 3B, but for a third unit of time, which may correspond to yet a different crop. In the example of FIGS. 3E and 3F, the total yield is 569 units, with an average of 23 units.

FIGS. 3G and 3H illustrate example yield maps and normalized productivity values, respectively, for the same field as in FIGS. 3A and 3B, but for a second unit of time, which may correspond to a different crop. In the example of FIGS. 3G and 3H, the total yield is 1610 units, with an average of 64 units. It will be noted that the lower right corner of the field displays a marked decline relative to the same field locations in preceding figures. Again, this may represent factors such as, e.g., a mechanical failure in seeding, flooding, or overspraying of pesticides affecting these field locations.

FIG. 31 illustrates a map of average of normalized productivity values taken for each field location from each of the maps of FIGS. 3B, 3D, 3F and 3H. It should be noted that transient factors, such as those that produce the low yield patterns noted in FIGS. 3C and 3G, have an impact on the average for those field locations.

The described embodiments, however, eliminate outlier values by computing filtered and normalized productivity values. For example, if upper and lower thresholds are set based on quartiles, then normalized productivity values below the lower threshold (e.g., in the first quartile) and normalized productivity values above the upper threshold (e.g., in the fourth quartile) are filtered out. In the examples described herein, the upper and lower thresholds are determined based on quartiles, however other thresholds may be used (e.g., upper and lower quintiles, deciles, or any other arbitrary thresholds such as single digit numerals).

Referring now to FIGS. 3J to 3M, there are illustrated normalized productivity values corresponding to FIGS. 3B, 3D, 3F and 3H, respectively. However, normalized productivity values that fall below the lower threshold, or above the upper threshold, are removed. In FIG. 3K, which corresponds to FIGS. 3C and 3D, it should be noted that the third column is entirely filtered out. Similarly, in FIG. 3M, which corresponds to FIGS. 3G and 3H, the locations in the lower right corner are also filtered out.

Averaged normalized productivity values of the field can be obtained, by averaging the remaining normalized productivity values following filtering. The result of averaging of the filtered normalized productivity values of FIGS. 3J to 3M is shown in FIG. 3N, and represents the productivity map for the field of FIGS. 3A to 3D. It should be noted that the values in the third column do not display any marked effect from the anomalies depicted in FIGS. 3C and 3D. In particular, the 3^{rd} column, 2^{nd} row location shows the highest R value in FIG. 3N, whereas in the general average of FIG. 3I, this location showed a markedly lower R value, due the effect of the anomaly in FIG. 3C.

In some embodiments, a clustering algorithm or other quantization approach may be used to delineate or bin productivity values into one of a predetermined number of productivity zones. For instance, in one approach, field locations may be assigned to one of three zones, representing low, medium and high productivity. If such an approach is used, then the map of FIG. 3N may be transformed into the map of FIG. 3O, where the numeral 1 is used to indicate a low productivity zone, the numeral 2 indicates a medium productivity zone, and the numeral 3 indicates a high productivity zone.

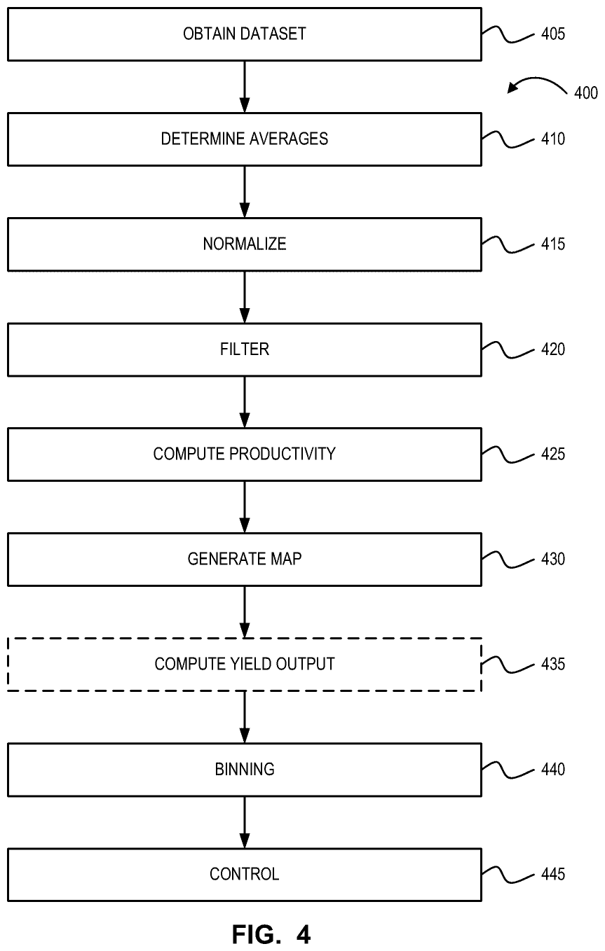

Referring now to FIG. 4, there is illustrated a flow chart diagram for a method of yield management in accordance with at least one embodiment. Method 400 may be carried out by system 100 of FIG. 1, which may include a processor and a spreader, for example.

Method 400 begins at 405 with obtaining a plurality of seasonal yield datasets for a field. The plurality of seasonal yield dataset contains point yields corresponding to a plurality of field locations which may be defined, e.g., according to a grid based on longitude and latitude.

If yield monitoring data from certain years are incomplete, missing, corrupted, or not calibrated well, vegetation indices obtained from satellite, aerial, or drone imagery can be used instead of yield data. Examples of vegetation indices can be (but are not limited to): Normalized Difference Vegetation Index (NDVI), Enhanced Vegetation index (EVI), etc. Since vegetation indices may have different ranges of values between classes compared to yield monitoring data, the vegetation index can be rescaled using the actual yield values from either historical or current yield monitoring data.

The process of using vegetation index data for generation of a yield dataset includes: (i) generation of a vegetation index dataset for the agricultural field; (ii) usage of a partial or whole yield monitoring dataset to obtain the yield range (i.e. minimum to maximum yield) for the agricultural field, and the average, field specific ratio between low, medium, and high yield classes and vegetation index classes within the field; and (iii) recalculation of vegetation index values to yield values using the ratio obtained in the step (ii).

At 410, the average yield for each of the yield datasets is determined, by summing each of the point yields for the respective dataset and dividing by the number of point yields in the respective dataset. This produces set of average values corresponding to the number of yield datasets.

At 415, each of yield datasets is normalized by computing normalized yield values, or productivity values. Each productivity value is computed by dividing a point yield by the seasonal average yield of the respective dataset. This produces a plurality of normalized yield values, or productivity values.

At 420, the plurality of normalized yield values are further filtered to eliminate outlier values and thereby generate a plurality of filtered normalized yield values, or filtered productivity values. The further filtering involves determining a lower threshold, such as a first quartile, and an upper threshold, such as a fourth quartile, across the plurality of normalized yield values for each of the seasonal yield datasets. For example, for a given field location, each of the productivity values from each of the seasonal datasets is analyzed to determine whether it falls between the lower and upper thresholds. Productivity values that fall within the lower and upper thresholds are retained and become the filtered normalized yield values, or filtered productivity values, whereas productivity values that fall below the lower threshold, or above the upper threshold, are eliminated or ignored.

Next, at 425, the filtered productivity values corresponding to each field location are averaged and, at 430, are used to generate a productivity map for the field.

Optionally, at 435, the productivity map may be used to compute an estimated yield output for the respective field for a particular crop. The estimated yield output may be based on a known yield output of the crop for a given productivity rating.

Further optionally, at 440, the productivity values of the productivity map may be delineated or binned into one of a predetermined number of values, thereby defining a predetermined set of productivity ranges. For example, a productivity value of 0.9 may correspond to a first of three ranges, and therefore the field location may be assigned to a first productivity range. The productivity ranges may be grouped to form management zones. Generally, the number of productivity ranges and/or management zones will be at least 3. Contours of management zones may be determined by clustering the plurality of productivity values.

Optionally, at 445, the productivity map—whether or not delineated—may be used to control a distribution device, such as a spreader or sprayer, to increase or decrease the rate of flow of seed, pesticide or fertilizer, according to the productivity range and/or management zone of the current field location relative to the productivity map.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g. 112a, or 112-1). All elements with a common base number may be referred to collectively or generically using the base number without a suffix (e.g. 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A method for yield data management, the method comprising:
obtaining a plurality of seasonal yield datasets for a field, each of the plurality of seasonal yield datasets containing a respective plurality of point yields corresponding to a plurality of locations of the field;
determining a plurality of seasonal average yields for the field based on the plurality of seasonal yield datasets;
for each of the plurality of seasonal yield datasets, computing a respective plurality of normalized yield values based on the respective plurality of point yields and the respective seasonal average yield for the field;
filtering the plurality of normalized yield values to eliminate outlier values and generate a plurality of filtered normalized yield values;
computing a plurality of productivity values, each of the productivity values corresponding to a respective location of the field, each of the productivity values based on the respective filtered normalized yield values corresponding to the respective location;
generating a productivity map for the field based on the plurality of productivity values.

2. The method of claim 1, wherein the obtaining the plurality of seasonal yield datasets for the field comprises using vegetation indices obtained from at least one of satellite, aerial, and drone imagery to substitute incomplete calibrated yield data.

3. The method of claim 2, wherein the vegetation indices are at least one of a Normalized Difference Vegetation Index (NDVI) or an Enhanced Vegetation index (EVI).

4. The method of claim 1, further comprising computing a yield output for the field for a crop based on the productivity map.

5. The method of claim 1, further comprising binning the plurality of productivity values based on a predetermined number of productivity ranges, to generate a plurality of binned productivity values.

6. The method of claim 5, wherein the predetermined number of productivity ranges is at least 2.

7. The method of claim 1, further comprising identifying a plurality of management zones on the productivity map based on the plurality of productivity values.

8. The method of claim 7, wherein contours of each of the plurality of management zones are determined by clustering the plurality of productivity values.

9. The method of claim 1, wherein the filtering comprises, for each location, eliminating one or more normalized yield values that exceed an upper threshold.

10. The method of claim 9, wherein the upper threshold is a fourth quartile of the plurality of normalized yield values for the respective location.

11. The method of claim 1, wherein the filtering comprises, for each location, eliminating one or more normalized yield values that exceed a lower threshold.

12. The method of claim 11, wherein the lower threshold is a first quartile of the plurality of normalized yield values for the respective location.

13. The method of claim 1, wherein the plurality of locations of the field are determined based on a grid pattern, and wherein the grid pattern is based on latitude and longitude.

14. The method of claim 1, further comprising instructing a spreader to increase or decrease spreading density based on a location of the spreader relative to the productivity map.

15. A system for yield management, the system comprising:
a memory storing a plurality of seasonal yield datasets for a field, each of the plurality of seasonal yield datasets containing a respective plurality of point yields corresponding to a plurality of locations of the field;
a processor, the processor configured to carry out the method of claim 1.

16. The system of claim 15, further comprising a spreader, wherein the processor is further configured to carry out the method of claim 14.

17. A non-transitory computer readable medium storing instructions executable by a computer processor, the instructions when executed for cause the processor to carry out the method claim 1.
